(19) United States
(12) Patent Application Publication
(10) Pub. No.: US 2020/0179193 A1
(43) Pub. Date: Jun. 11, 2020

(54) STRETCHER PROTECTIVE COVER

(71) Applicant: EXO-Shell, LLC, Farmington Hills, MI (US)

(72) Inventors: Vernon Guillermo, Farmington Hills, MI (US); Stanley E. Barnes, Farmington Hills, MI (US)

(73) Assignee: EXO-Shell, LLC, Farmington Hills, MI (US)

(21) Appl. No.: 16/708,693

(22) Filed: Dec. 10, 2019

Related U.S. Application Data
(60) Provisional application No. 62/777,331, filed on Dec. 10, 2018.

(51) Int. Cl. A61G 1/04

(52) U.S. Cl. CPC A61G 1/04

(57) ABSTRACT

A protective cover for stretchers and gurneys is provided that offers protection from the elements and a measure of privacy to a patient lying on a stretcher. The protective stretcher cover is readily formed from a cross member with a pair of pivoting arms that deploy from opposing ends of the single cross member, the pivoting arms having a shielding material extending therebetween. The shielding material extending far enough from the first side of the stretcher to either form an arcuate cover over a portion of the stretcher surface, or join with a complementary cross member extending from an opposing side of the stretcher. Regardless of whether a single cross member or opposing pair thereof are used, the distal edge of the shielding material, pivot arms, or combination thereof includes a securement to retain the arcuate form of a deployed shield.

### RELATED APPLICATIONS

This application claims priority benefit of U.S. Provisional Application Ser. No. 62/777,331 filed Dec. 10, 2018, the contents of which are hereby incorporated by reference.

### TECHNICAL FIELD

The present invention generally relates to the field of medical transport, and in particular to a stretcher protective cover.

### BACKGROUND

A stretcher is a platform used for moving patients who require medical care from the field to a location where medical equipment is concentrated, such as an aid station or emergency room. Stretchers are lightweight and portable, and traditionally made of fabric materials suspended between two poles, a tubular aluminum frame, or a padded rigid backing bounded by a frame. A basic stretcher is carried by two or more people or supported by a wheeled base. A wheeled stretcher or gurney is often equipped with variable height frames, wheels, tracks, or skids. However, the open design of stretchers offers little or no protection for a patient being carried on a stretcher from the surrounding elements including precipitation and wind, or privacy from onlookers present at an accident scene or treatment location. While there have been attempts to provide a protective covering, these have met with limited success owing to the impediment such coverings have unintentionally created in the working area and ventilation afforded around the patient.

Thus, there exists a need for a protective cover that attaches to a stretcher that provides protection and privacy from the elements and onlookers for a patient being transported on a stretcher while overcoming the aforementioned impediments.

### SUMMARY

A protective cover for stretchers is provided that includes a cross member with a pair of pivoting arms extending from opposing ends of the cross member, a foldable shielding material between the pair of pivoting arms, and at least one securement on the pair of pivoting arms or the foldable shielding material. The at least one securement joins the pair of pivot arms across opposing sides of the stretcher.

A method is provided of using the disclosed protective cover for a stretcher. The method includes attaching the cross member in a non-deployed state to a first lengthwise side of the stretcher. The pair of pivoting arms are then deployed upward from the cross member to extend the foldable shielding material between the pair of pivoting arms. Subsequently, the pair of pivoting arms are bent toward an opposing second lengthwise side of the stretcher to form an arch that forms a covered area over a stretcher bed of the stretcher. The pair of pivoting arms are then secured to the opposing second lengthwise side of the stretcher or a complementary pair of opposing pivoting arms extended from the opposing second lengthwise side.

### BRIEF DESCRIPTION OF THE DRAWINGS

The present invention is further detailed with respect to the following drawings that are intended to show certain aspects of the present of invention, but should not be construed as limit on the practice of the invention, wherein:

FIG. 1 is a perspective view of a stretcher with an attached protective cover deployed in accordance with embodiments of the invention;

FIGS. 2A-2C are a series of perspective views of various stages of deployment of an embodiment of the protective cover of FIG. 1 in accordance with embodiments of the invention from fully stowed (FIG. 2A), to partially deployed (FIG. 2B), to fully deployed (FIG. 2C);

FIGS. 3A-3C are a series of perspective views of various stages of deployment of an embodiment of the protective cover of FIG. 1 in accordance with embodiments of the invention from initial deployment (FIG. 3A), partially deployed (FIG. 3B), to fully deployed (FIG. 3C); and

FIG. 4 illustrates the steps of deploying the protective cover of FIG. 1 with a stretcher in accordance with embodiments of the invention.

### DETAILED DESCRIPTION

The present invention has utility as a protective cover for stretchers. Embodiments of the inventive protective stretcher cover provide protection from the elements and a measure of privacy to a patient lying on a stretcher. As used herein, the term stretcher is defined as a generally planar apparatus used for moving patients who require medical care specifically intended to include wheeled versions thereof that are commonly referred to as gurneys.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Embodiments of the protective stretcher cover are readily formed from a cross member with a pair of pivoting arms that deploy from opposing ends of the single cross member, the pivoting arms having a shielding material extending therebetween. The shielding material extending far enough from the first side of the stretcher to either form an arcuate cover over a portion of the stretcher surface, or join with a complementary cross member extending from an opposing side of the stretcher. Regardless of whether a single cross member or opposing pair thereof are used, the distal edge of the shielding material, pivot arms, or combination thereof includes a securement to retain the arcuate form of a deployed shield.

The cross member and pivoting arms are illustratively formed of metal, fiber glass, thermoplastics, thermoset resins, or a combination thereof, where the pair of pivoting arms are bendable with a bias or memory to return to their non-bent state. Securements illustratively include clips, snaps, hooks, zippers, hook and loop fasteners, or a combination thereof. Attached to the cross member and the pair of pivoting arms is a foldable shielding material, which when the pair of pivoting arms are deployed outward unfolds and stretches the material to form a covering surface. The shielding material may range from opaque to transparent, where specific regions or portions of the shielding material may be transparent. The shielding material may be a canvas or woven material, plastic, a metal foil, or a combination thereof. In some inventive embodiments, the shielding material is a mesh-like fabric. Affixed to the cross member and the pair of pivoting arms are securements to attach the protective stretcher cover to the sides of a stretcher. Embodiments of the protective stretcher cover may be fastened or clipped to the sides of a stretcher. Embodiments of the protective stretcher cover are compact when not deployed, and may be folded into a carrying bag when not in use thereby not interfering with the working area above the patient receiving surface. In a specific embodiment, the protective cover may be permanently joined to the stretcher. The length of the protective stretcher cover may vary from under less than half the length of the stretcher to the full length of the stretcher. In a specific inventive embodiment, the stretcher cover is 3 to 5 feet in length which is approximately three quarters of the length of a typical stretcher. In instances where the length of the protective stretcher cover is less than the length of the stretcher, more than one stretcher cover may be combined to cover the entire patient on the stretcher.

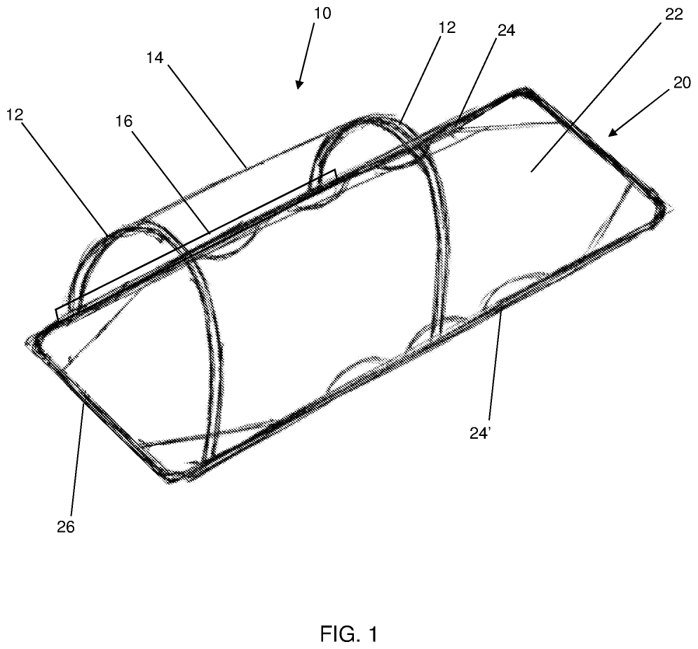

Referring now to the figures, FIG. 1 is a perspective view of an attached protective cover 10 deployed over a stretcher 20. As shown the cross member 16 that attaches to elongated side 24 of the stretcher 20 is approximately half the length of the stretcher 20 as defined by the elongated sides (24, 24′). It is appreciated that the length of the cross member 16 may range up to the full length of the stretcher. The pair of pivoting arms 12 are bent toward the opposing elongated side 24′ to form an arch. The width of the arch is defined by the opposing end members 26 of the stretcher 20. The foldable shielding material 14 is shown as transparent for visual clarity, and is suspended by bent pair of pivoting arms 12 to form a covered area over the bed 22 of the stretcher 20.

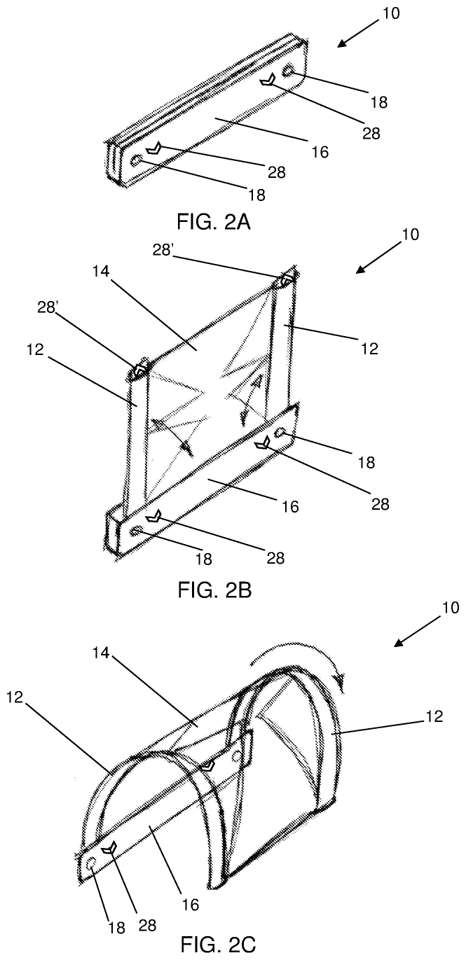

FIGS. 2A-2C are a series of perspective views of various stages of deployment of an embodiment of the protective cover 10 of FIG. 1. In FIG. 2A the pair of pivoting arms 12, which are attached to the cross member 16 by pivot joints 18, are in a stored or folded position for compact storage, as shown in FIG. 2A. Also visible in FIG. 2A are the securements 28 on the cross member 16 for attachment to the stretcher 20. In FIG. 2B, the pair of pivoting arms 12 are deployed upward away from the cross member 16 to unfold and stretch the foldable shielding material 14. Also visible in FIG. 2B are securements 28′ for attachment to side 24′ of the stretcher 20. In FIG. 2C, the pair of deployed pivoting arms 12 are bent to form an arch that forms the covered area over the stretcher bed. It is appreciated that in a dual cross member embodiment, where opposing pivot arms 12 join a like opposing pair of pivot arms by way of a joinder, this typically occurs generally in the vicinity of the apex of the arch defined by the shielding material 14 with the opposing complementary shielding material. The joinder is readily positioned on the shielding material, the pivot arms, or a combination thereof and illustratively includes the structures detailed herein as securements.

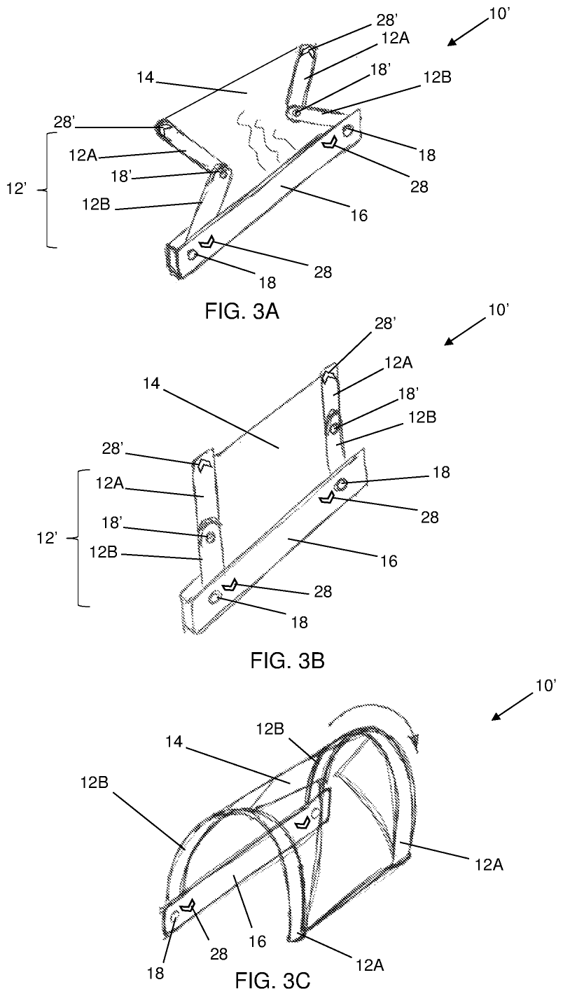

FIGS. 3A-3C are a series of perspective views of various stages of deployment of an embodiment 10′ of the protective cover 10 of FIG. 1. In FIG. 3A a pair of articulated pivoting arms 12′ have pivot joints 18′ that divide the articulated pivoting arms 12′ into segments 12A and 12B, which are attached to the cross member 16 by pivot joints 18. The addition of pivot joints 18′ to the articulated pivoting arms 12′ allows for an even more compact design of the inventive protective cover. In a specific inventive embodiment, the stretcher cover is 1.5 to 5 feet in length. Also visible in FIG. 3A are the securements 28 on the cross member 16 for attachment to the stretcher 20. In FIG. 3B, the pair of pivoting arms 12′ are deployed fully upward away from the cross member 16 to unfold and stretch the foldable shielding material 14. Also visible in FIG. 3B are securements 28′ for attachment to side 24′ of the stretcher 20. In FIG. 3C, the pair of articulated deployed pivoting arms 12′ are bent to form an arch that forms the covered area over the stretcher bed.

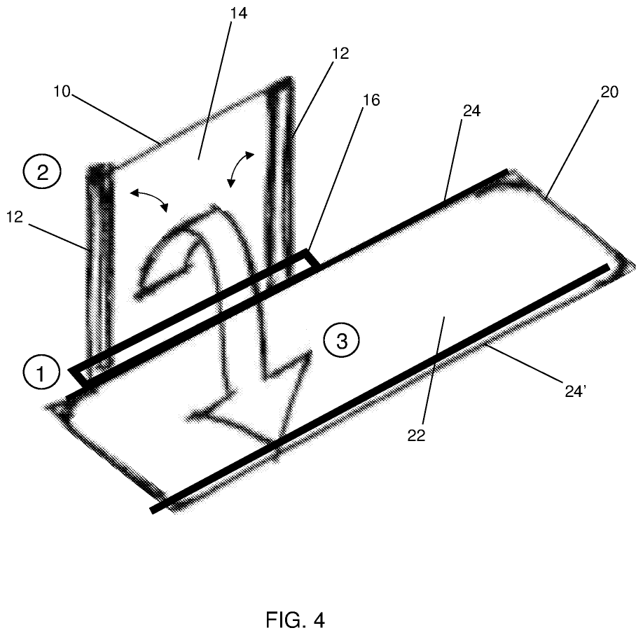

FIG. 4 illustrates the steps of deploying embodiments the protective cover 10 with a stretcher 20. In step 1, the protective cover 10 is attached to the stretcher 20 (if not already attached). In step 2, the pair of pivoting arms 12 are deployed upward away from the cross member 16 to unfold and stretch the foldable shielding material 14. In step 3, the pair of pivoting arms 12 are bent toward the attachment to side 24′ of the stretcher 20, and secured to form an arch that forms the covered area over the stretcher bed 22.

### Other Embodiments

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient roadmap for implementing the exemplary embodiment or exemplary embodiments. It should be understood that various changes may be made in the function and arrangement of elements without departing from the scope as set forth in the appended claims and the legal equivalents thereof.

1. A protective cover for stretchers comprising:
a cross member with a pair of pivoting arms extending from opposing ends of the cross member;
a foldable shielding material between said pair of pivoting arms; and
at least one securement on said pair of pivoting arms or said foldable shielding material.

2. The cover of claim 1 wherein said at least one securement joins said pair of pivot arms across opposing sides of the stretcher.

3. The cover of claim 1 wherein said cross member is secured to a first side of the stretcher.

4. The cover of claim 1 wherein said at least one securement is a clip, a snap, a hook, a zipper, a hook and loop fastener, or a combination thereof.

5. The cover of claim 1 wherein said foldable shielding material ranges from opaque to transparent, where specific regions or portions of the shielding material may be transparent.

6. The cover of claim 1 wherein said foldable shielding material is at least one of a woven material, plastic, a metal foil, or a combination thereof.

7. The cover of claim 1 further comprising an opposing cross member with a pair of opposing pivoting arms, said opposing cross member secured to an opposing side of said stretcher relative to said cross member, an opposing foldable shielding material extending between said pair of opposing pivoting arms.

8. The cover of claim 7 further comprising a joinder between said pair of pivoting arms and said pair of opposing pivoting arms.

9. The cover of claim 8 wherein said joinder is positioned at or near an apex of an arch defined by the cover when fully deployed.

10. The cover of claim 1 wherein a distance between said pair of pivoting arms is between half a length of the stretcher to a full length of the stretcher.

11. The cover of claim 1 wherein said pair of pivoting arms further comprise a pivot joint that divides each of said pair of pivoting arms into segments that articulate about the pivot joint.

12. A method of using the protective cover for a stretcher of claim 1, said method comprising:
attaching said cross member in a non-deployed state to a first lengthwise side of the stretcher;
deploying said pair of pivoting arms upward from said cross member to extend said foldable shielding material between said pair of pivoting arms; and
bending said pair of pivoting arms toward an opposing second lengthwise side of the stretcher to form an arch that forms a covered area over a stretcher bed of the stretcher; and
securing said pair of pivoting arms to said opposing second lengthwise side of the stretcher or a complementary pair of opposing pivoting arms extended from said opposing second lengthwise side.
